(19) United States
(12) Patent Application Publication
(10) Pub. No.: US 2014/0042153 A1
(43) Pub. Date: Feb. 13, 2014

(54) MICROWAVE PROCESSING METHOD AND MICROWAVE PROCESSING APPARATUS

(71) Applicant: TOKYO ELECTRON LIMITED, Minato-ku (JP)

(72) Inventors: Kouji Shimomura, Yamanashi (JP); Yoshiro Kabe, Yamanashi (JP); Taichi Monden, Yamanashi (JP); Jun Yamashita, Yamanashi (JP); Kunio Takano, Yamanashi (JP); Satoshi Gomi, Yamanashi (JP)

(73) Assignee: TOKYO ELECTRON LIMITED, Minato-ku (JP)

(21) Appl. No.: 13/957,643

(22) Filed: Aug. 2, 2013

(30) Foreign Application Priority Data
Aug. 8, 2012 (JP) 2012-175962

(51) Int. Cl. H05B 6/80

(52) U.S. Cl. CPC H05B 6/80
USPC 219/686

(57) ABSTRACT

A microwave processing method for processing an object in a processing chamber is probided by using microwaves. The method includes loading the object into the processing chamber in a state where a pressure in the processing chamber is higher than that of an outside environment; discharging O₂ gas from the processing chamber by introducing N₂ gas into the processing chamber; performing heat treatment on the object by introducing microwaves into the processing chamber from which the O₂ gas has been discharged; and cooling the object in a state where the pressure in the chamber is higher than that of the outside environment.

### CROSS-REFERENCE TO RELATED APPLICATION

This application claims priority to Japanese Patent Application No. 2012-175962 filed on Aug. 8, 2012, the entire contents of which are incorporated herein by reference.

### FIELD OF THE INVENTION

The present invention relates to a microwave processing method and a microwave processing apparatus.

### BACKGROUND OF THE INVENTION

In a semiconductor wafer (hereinafter, simply referred to as “wafer”) as an object to be processed, crystallization of amorphous silicon or activation of doped impurities is generally realized by heat treatment using a lamp heater. With such heat treatment, the amorphous silicon is fused by heating, and the impurities are activated by heating.

In the heat treatment using a lamp heater, the wafer surface is heated and the heat is transmitted to a portion that needs to be heated. This may cause a shape of a trench or a hole in the surface of the wafer to collapse. Recently, heat treatment using a microwave is being studied (see, e.g., Japanese Patent Application No. 2012-040095). In the heat treatment using a microwave, when dipoles of impurities exist in a wafer to which microwaves are irradiated, for example, the dipoles are vibrated by the microwaves, thereby generating frictional heat. The vicinity of the dipoles is heated by the frictional heat (dielectric heating). In other words, by positioning dipoles at a portion of the wafer which needs to be heated, only the corresponding portion can be selectively heated.

In the heat treatment using a microwave, in order to omnidirectionally irradiate microwaves to the wafer, the microwaves are introduced into a chamber accommodating therein a wafer and then reflected from inner surfaces of the chamber so as to be scattered in the chamber. The scattered microwaves easily cause abnormal discharge. Therefore, the chamber is maintained substantially at the atmospheric pressure in order to suppress occurrence of abnormal discharge.

On the surface of the wafer, various films constituting semiconductor devices are formed, and such films include a film containing metal. Meanwhile, since the atmosphere containing O₂ exists in the chamber and the wafer is heated by microwaves, oxides may be generated on the surface of the wafer by thermal oxidation. For example, when silicide is generated on the surface of the wafer by the heat treatment using a microwave, the silicide is mixed with the oxides. Accordingly, the generation of undesired oxides needs to be suppressed in the heat treatment using a microwave.

### SUMMARY OF THE INVENTION

In view of the above, the present invention provides a microwave processing method and a microwave processing apparatus which can suppress the generation of oxides during heat treatment using a microwave.

In accordance with an aspect of the present invention, there is provided a microwave processing method for processing an object in a processing chamber using microwaves, including loading the object into the processing chamber in a state where a pressure in the processing chamber is higher than that of an outside environment; discharging O₂ gas from the processing chamber by introducing N₂ gas into the processing chamber; performing heat treatment on the object by introducing microwaves into the processing chamber from which the O₂ gas has been discharged; and cooling the object in a state where the pressure in the chamber is higher than that of the outside environment.

In accordance with another aspect of the present invention, there is provided a microwave processing apparatus including a processing chamber configured to accommodate therein an object to be processed; a microwave introducing unit configured to introduce microwaves into the processing chamber; and a gas introducing unit configured to introduce N₂ gas into the processing chamber, wherein the gas introducing unit introduces the N₂ gas into the processing chamber, prior to the introduction of the microwaves into the processing chamber by the microwave introducing unit, to allow O₂ gas to be discharged from the processing chamber.

### BRIEF DESCRIPTION OF THE DRAWINGS

The above and other objects and features of the present invention will become apparent from the following description of embodiments, given in conjunction with the accompanying drawings, in which:

FIG. 1 is a cross sectional view schematically showing a configuration of a microwave processing apparatus in accordance with an embodiment of the present invention;

FIG. 2 is a flowchart of microwave heat treatment performed by the microwave processing apparatus shown in FIG. 1;

FIG. 3 is a cross sectional view for explaining injection of N₂ gas onto a surface of a wafer rotating horizontally in the microwave processing apparatus shown in FIG. 1;

FIG. 4 is a bottom view of a ceiling portion shown in FIG. 1, viewed from inside of the chamber;

FIG. 5 is a cross sectional view for explaining movement of a wafer during heat treatment of the wafer in the microwave processing apparatus shown in FIG. 1;

FIG. 6 is a cross sectional view schematically showing a configuration of a first modification of the microwave processing apparatus shown in FIG. 1;

FIG. 7 is a cross sectional view schematically showing a configuration of a second modification of the microwave processing apparatus shown in FIG. 1; and

FIG. 8 is a cross sectional view schematically showing a configuration of a third modification of the microwave processing apparatus shown in FIG. 1.

### DETAILED DESCRIPTION OF THE EMBODIMENTS

Hereinafter, embodiments of the present invention will be described with reference to the accompanying drawings which form a part hereof.

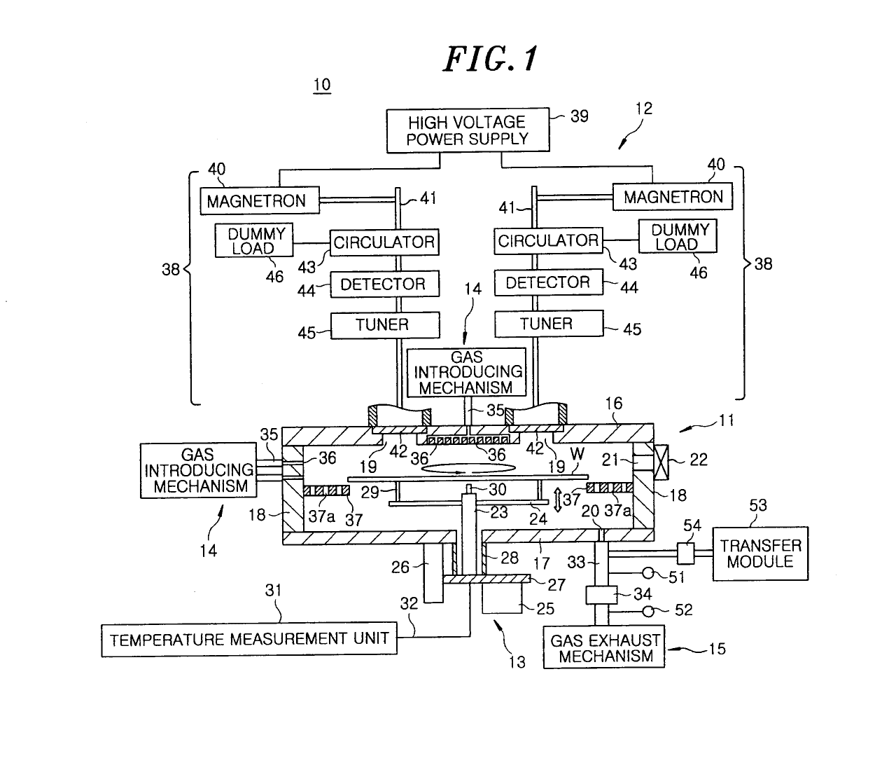

Referring to FIG. 1, a microwave processing apparatus 10 includes: a chamber (processing chamber) 11 accommodating therein a wafer W (object to be processed); a microwave introducing mechanism 12 (microwave introducing unit) for introducing microwaves into the chamber 11; a supporting mechanism 13 for supporting a wafer W in the chamber 11; a gas introducing mechanism 14 (gas introducing unit) for introducing a predetermined gas into the chamber 11; and a gas exhaust mechanism 15 (gas exhaust unit) for evacuating the chamber 11.

The chamber 11, which has, e.g., a rectangular parallelepiped shape, includes a plate-shaped ceiling portion 16, a bottom portion 17 opposite to the ceiling portion 16, and sidewalls 18 for connecting the ceiling portion 16 and the bottom portion 17. The ceiling portion 16, the bottom portion 17, and the sidewalls 18 are made of metal, e.g., aluminum or stainless steel. The ceiling portion 16 has a plurality of microwave inlet ports 19 penetrating therethrough in a vertical direction as shown in the drawing (hereinafter, simply referred to as “vertical direction”). The bottom portion 17 has a gas exhaust port 20. The inner surface of each of the sidewalls 18 is flat and reflects the microwaves introduced into the chamber 11. Further, a loading/unloading port 21 of the wafer W is provided at one of the sidewalls 18. A gate valve 22 is provided at the loading/unloading port 21 and moves in a vertical direction to open and close the loading/unloading port 21.

The supporting mechanism 13 has a shaft 23 extending through the bottom portion 17 along the vertical direction; a plurality of arms 24 extending in a horizontal direction, as shown in FIG. 1, from an upper portion of the shaft 23; a rotation driving unit 25 for rotating the shaft 23; an elevation driving unit 26 for vertically moving the shaft 23; and a shaft base portion 27, to which the rotation driving unit 25 and the elevation driving unit 26 are attached, serving as a base of the shaft 23. The shaft 23 is isolated from the outside of the chamber 11 by a bellows 28 covering the shaft 23.

In the supporting mechanism 13, the wafer W is supported by pins 29 protruding from the leading ends of the arms 24. In the chamber 11, the wafer W mounted on the arms 24 is rotated in a horizontal plane (indicated by a black arrow in FIG. 1) by the rotation of the shaft 23 and moved in a vertical direction by the elevating movement of the shaft 23 (indicated by a white arrow). Further, a radiation thermometer 30 for measuring a temperature of the wafer W is provided at the leading end of the shaft 23 and is connected through wiring 32 to a temperature measurement unit 31 provided outside the chamber 11.

The gas introducing mechanisms 14 provided at the ceiling portion 16 and the sidewall 18 are connected to a plurality of gas inlet ports 36 that are opened at the ceiling portion 16 and the sidewall 18 via a plurality of lines 35. Accordingly, a processing gas, a cooling gas, or a purge gas, e.g., N₂ gas, Ar gas, He gas, Ne gas, O₂ gas, or H₂ gas, is introduced into the chamber 11 in a downflow manner and a sideflow manner. Each of the lines 35 is provided with a mass flow controller (not shown) and an opening/closing valve (not shown), which control a type and a flow rate of the processing gas, the cooling gas, or the purge gas. In FIG. 1, the gas inlet port 36 is opened at the ceiling portion 16 and the sidewall 18. However, a stage for mounting thereon a wafer W may be provided at the supporting mechanism 13 and a plurality of gas inlet ports may be opened at the mounting surface of the stage so that the purge gas and the like may be introduced into the chamber 11 in an upflow manner.

The gas exhaust mechanism 15 has a gas exhaust unit such as a dry pump or the like and is connected to a gas exhaust port 20 through a gas exhaust line 33. The gas exhaust port 20 is provided near the sidewall 18 that is opposite to the sidewall 18 where the gas inlet port 36 is provided. Accordingly, the purge gas and the like introduced through the gas inlet port 36 of the sidewall 18 are moved in a horizontal direction in the chamber 11 and flows along the surface of the wafer W. Further, a pressure control valve 34 is provided in the gas exhaust line 33 to control a pressure in the chamber 11.

Further, micro-differential pressure gauges 51 and 52 are respectively provided at an upstream and a downstream side of the pressure control valve 34 to monitor whether or not the pressure is in a higher pressure state or a lower pressure state than the atmospheric pressure. Due to the monitoring of the micro-differential pressure gauges 51 and 52, the pressure in the chamber 11 is maintained at a desired higher pressure state or a lower pressure state. Moreover, the gas exhaust line 33 at the upstream side of the pressure control valve 34 is branched and connected to a transfer module (loader module) 35 maintained at the atmospheric pressure. A relief valve 54 is disposed between the gas exhaust line 33 and the transfer module 53. When the pressure in the chamber 11 reaches an overpressurized state, the relief valve 54 is opened so that the pressure in the chamber 11 is released to the transfer module 53 and falls within a safe range. Further, the pressure in the chamber 11 is maintained in a higher pressure state than the outside.

Moreover, it is not necessary to provide the gas exhaust mechanism 15 at the microwave processing apparatus 10. When the gas exhaust mechanism 15 is not provided, the gas exhaust port 20 is directly connected to a gas exhaust line of a gas exhaust equipment in a factory where the microwave processing apparatus 10 is installed.

In the processing chamber 11, a rectifying plate 37 is provided between the arms 24 and the sidewalls 18. The rectifying plate 37 has a plurality of through holes 37a. The flow of atmosphere near the wafer W is regulated by allowing atmosphere in the chamber 11 to flow through the through holes 37a.

The microwave introducing mechanism 12 is disposed above the ceiling portion 16 and includes a plurality of microwave units 38 for introducing a microwave into the chamber 11 and a high voltage power supply 39 connected to the microwave units 38.

Each of the microwave units 38 has a magnetron 40 for generating a microwave, a waveguide 41 for transmitting the generated microwave to the chamber 11, and a transmission window 42 fixed to the ceiling portion 16 so as to cover the microwave inlet ports 19.

The magnetrons 40 are connected to the high voltage power supply 39. Using a high voltage current supplied from the high voltage power supply 39, the magnetrons generate microwaves of various frequencies, e.g., 2.45 GHz or 5.8 GHz. Each of the magnetron 40 selectively generates a microwave having a frequency suitable for heat treatment performed by the microwave processing apparatus 10.

The waveguide 41 has a rectangular cross section and a square column shape. The waveguide 41 is installed upward from the microwave inlet port 19 to connect the magnetron 40 and the transmission window 42. The magnetron 40 is provided near the upper end of the waveguide 41. The microwave generated by the magnetron 40 is transmitted in the waveguide 41 and introduced into the chamber 11 through the transmission window 42.

The transmission window 42 is made of a dielectric material, e.g., quartz or ceramic. The gap between the transmission window 42 and the ceiling portion 16 is airtightly sealed by a sealing member. The distance from the transmission window 42 to the wafer W supported by the arms 24 is preferably, e.g., about 25 mm or more.

Each of the microwave units 38 further has a circulator 43, a detector 44, and a tuner 45, and a dummy load 46 connected to the circulator 43. The circulator 43, the detector 44, and the tuner 45 are sequentially arranged on the waveguide 41 in that order from the top. The circulator 43 and the dummy load 46 serve as isolators of the microwaves reflected from the inside of the chamber 11. The dummy load 46 converts the reflected wave separated from the waveguide 41 by the circulator 43 into heat to be consumed.

The detector 44 detects the reflected wave from the inside of the chamber 11, and the tuner 45 matches an impedence between the magnetron 40 and the chamber 11. The tuner 45 has a conductor plate (not shown) that can protrude into the waveguide 41 and adjusts the impedence by controlling the protrusion amount of the conductor plate such that the power of the reflected wave is minimized.

In the microwave processing apparatus 10, the microwaves introduced into the chamber 11 are reflected by the inner surfaces of the sidewalls 18 and the like and scattered. The scattered microwaves are omnidirectionally irradiated to the wafer W. The microwaves irradiated to the wafer W vibrate dipoles in the wafer W, thereby generating frictional heat. The wafer W is heated by the frictional heat. In other words, the heat treatment using a microwave is carried out. At this time, the shaft 23 is rotated to rotate the wafer W in the horizontal direction, so that the scattered microwaves can be irradiated to each portion of the wafer W. When the chamber 11 is depressurized while the microwaves are being scattered, abnormal discharge may occur. Therefore, when the microwaves are irradiated to the wafer W, the inside of the processing chamber 31 is maintained substantially at the atmospheric pressure by the pressure control of the pressure control valve 34 of the gas exhaust mechanism 15 and the gas supply from the gas introducing unit 14.

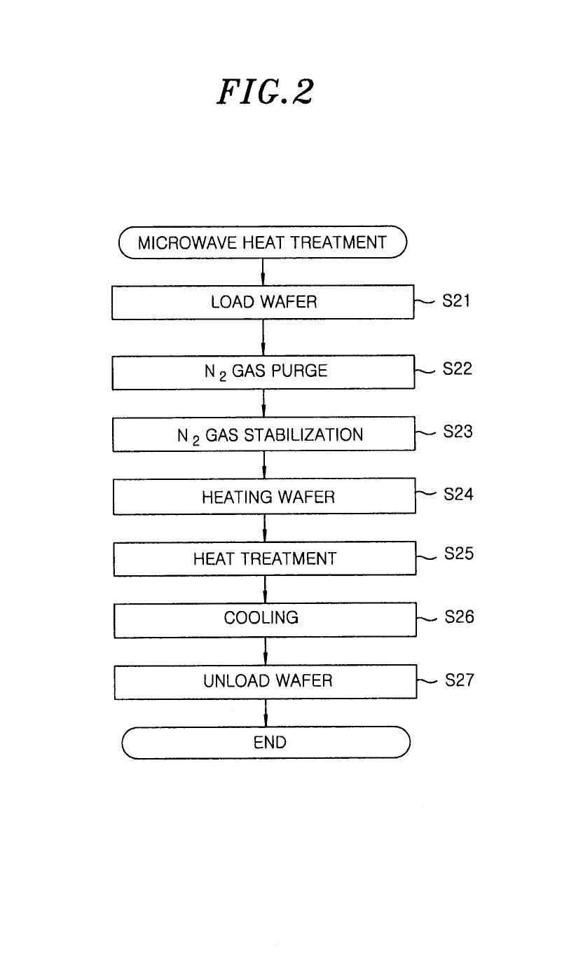

FIG. 2 is a flowchart of a microwave heat treatment (microwave processing method) performed by the microwave processing apparatus 10 shown in FIG. 1.

First, the pressure in the chamber 11 is set to a higher pressure than that of the outside environment by the pressure control of the pressure control valve 34 of the gas exhaust mechanism 15 and the gas supply from the gas introducing mechanism 14. Then, the loading/unloading port 21 is opened by the gate valve 22, so that the wafer W is loaded through the loading/unloading port 21 into the chamber 11 (loading step) (step S21) and supported by the supporting mechanism 13. The supporting mechanism 13 rotates the wafer W in a horizontal plane, as shown in FIG. 1, in order to prevent a very small amount of particles floating in the chamber 11 from being attached to the surface of the wafer W. For example, even if the particles are attached to the surface of the wafer W, the particles can be moved toward the periphery of the wafer W by the centrifugal force generated by the rotation of the wafer W to be removed from the surface of the wafer W.

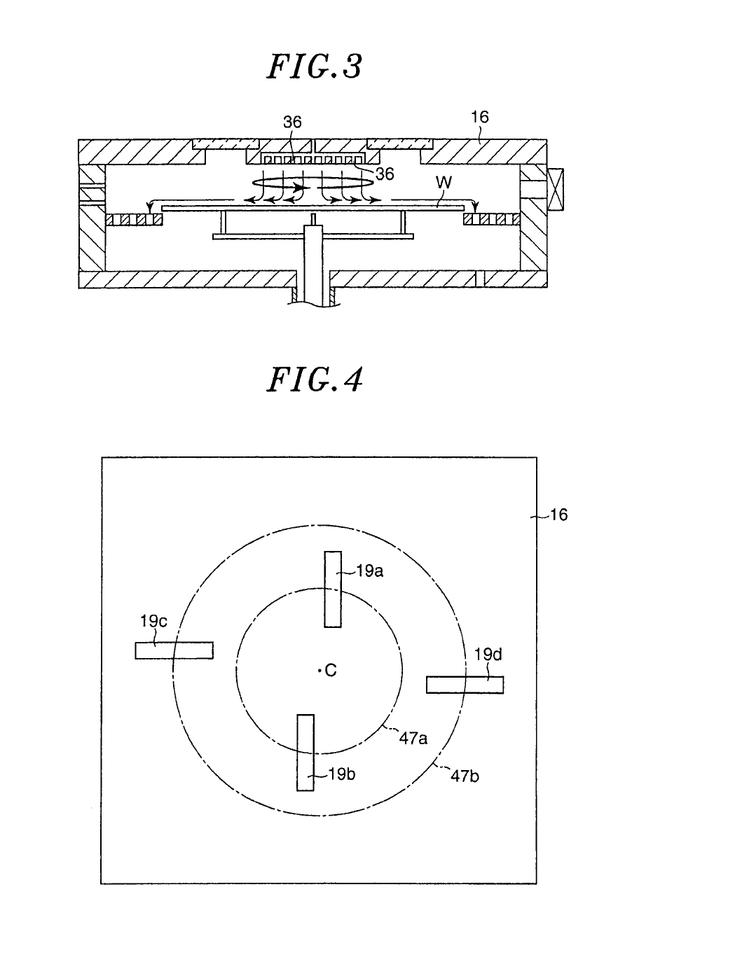

Next, N₂ gas is introduced at a high flow rate into the chamber 11 by the gas introducing mechanisms 14, and the atmosphere (containing O₂ gas) in the chamber 11 is extruded and discharged to the outside of the chamber 11 through the gas exhaust port 20 (O₂ gas discharge step) (step S22). At this time, as shown in FIG. 3, N₂ gas is injected onto the surface of the rotating wafer W through the gas inlet ports of the gas introducing mechanism 14 provided at the ceiling portion 16. The injected N₂ gas flows toward the peripheral portion of the wafer W along the surface thereof by the centrifugal force due to the friction with the surface of the wafer W (indicated by the thinner arrows in FIG. 3).

Accordingly, O₂ gas existing near the surface of the wafer W on which semiconductor devices are formed can be extruded and reliably removed by N₂ gas. Further, when the atmosphere in the chamber 11 is extruded and discharged by N₂ gas, the wafer W is vertically moved by the supporting mechanism 13 and located at a position suitable for the heat treatment using a microwave.

Next, the flow rate of N₂ gas in the chamber 11 is stabilized by gradually decreasing the flow rate of N₂ gas introduced from the gas introducing mechanisms 14 (step S23). At this time as well, N₂ gas injected onto the surface of the wafer W flows toward the peripheral portion of the wafer W by centrifugal force, thereby extruding and removing O₂ gas existing near the surface of the wafer W. The horizontal rotation of the wafer W by the supporting mechanism 13 may be started after the flow of N₂ gas in the chamber 11 is stabilized. In this case as well, O₂ gas existing near the surface of the wafer W and the particles can be removed by the centrifugal force due to the horizontal rotation of the wafer W.

Next, the introduction of N₂ gas into the chamber 11 is stopped, and the microwaves are introduced into the chamber 11 by the microwave introducing mechanism 12 while rotating the wafer W in a horizontal plane. The microwaves are reflected by the inner surfaces such as the sidewalls 18 of the chamber 11 and the like and scattered. The scattered microwaves are omnidirectionally irradiated to the wafer W, and the wafer W is heated to a desired heat treatment temperature (step S24).

Next, after the temperature of the wafer W reaches the desired heat treatment temperature, the amount of the microwaves to be introduced into the chamber 11 is controlled, and the heat treatment is performed on the wafer W while maintaining the temperature of the wafer W at the desired heat treatment temperature (heat treatment step) (step S25.) The step S24 and/or the step S25 may be continued without stopping the introduction of N₂ gas.

The microwaves are scattered in the chamber 11. However, the microwaves are localized due to generation of standing waves and non-uniform scattering of the microwaves in the chamber 11. Therefore, the amount of microwaves irradiated to each portion of the wafer W is not uniform. To this end, in the present embodiment, the wafer W is rotated in a horizontal plane. Accordingly, the total irradiation amount of microwaves in the circumferential direction of the wafer W becomes uniform, and the wafer W is uniformly heated in the circumferential direction. Moreover, the total irradiation amount of the microwave in the diametric direction of the wafer W becomes uniform by offsetting the positions of the microwave inlet ports 19 with respect to one another.

FIG. 4 is a bottom view of the ceiling portion shown in FIG. 1, viewed from inside of the chamber.

Referring to FIG. 4, microwave inlet ports 19a and 19b are disposed on the same circumference 47a, and microwave inlet ports 19c and 19d are disposed on the same circumference 47b. The centers of the circumferences 47a and 47b coincide with the center C of the ceiling portion 16, and the circumference 47b has a radius greater than that of the circumference 47a. Here, the center C of the ceiling portion 16 coincides with the center of the wafer W supported by the supporting mechanism 13, so that the microwave inlet ports 19c and 19d are offset with respect to the microwave inlet ports 19a and 19b in the radial direction of the wafer W.

In this case, the amounts of microwaves irradiated through the microwave inlet ports 19a and 19b and through the microwave inlet ports 19c and 19d are controlled in accordance with the microwave distribution pattern in the radial direction of the wafer W in the chamber 11. Specifically, when a larger amount of microwaves is irradiated to the central portion of the wafer W in the radial direction of the wafer W, the microwave irradiation amount in the radial direction of the wafer W becomes uniform by relatively decreasing the amount of microwaves irradiated through the microwave inlet ports 19a and 19b and relatively increasing the amount of microwaves irradiated through the microwave inlet ports 19c and 19d.

Further, when a larger amount of microwaves is irradiated to the peripheral portion of the wafer W in the radial direction of the wafer W, the microwave irradiation amount in the radial direction of the wafer W becomes uniform by relatively increasing the amount of microwaves irradiated through the microwave inlet ports 19a and 19b and relatively decreasing the amount of microwaves irradiated through the microwave inlet ports 19c and 19d. As a consequence, the total irradiation amount of the microwaves in the diametric direction of the wafer W becomes uniform, and the wafer W is uniformly heated in the radial direction.

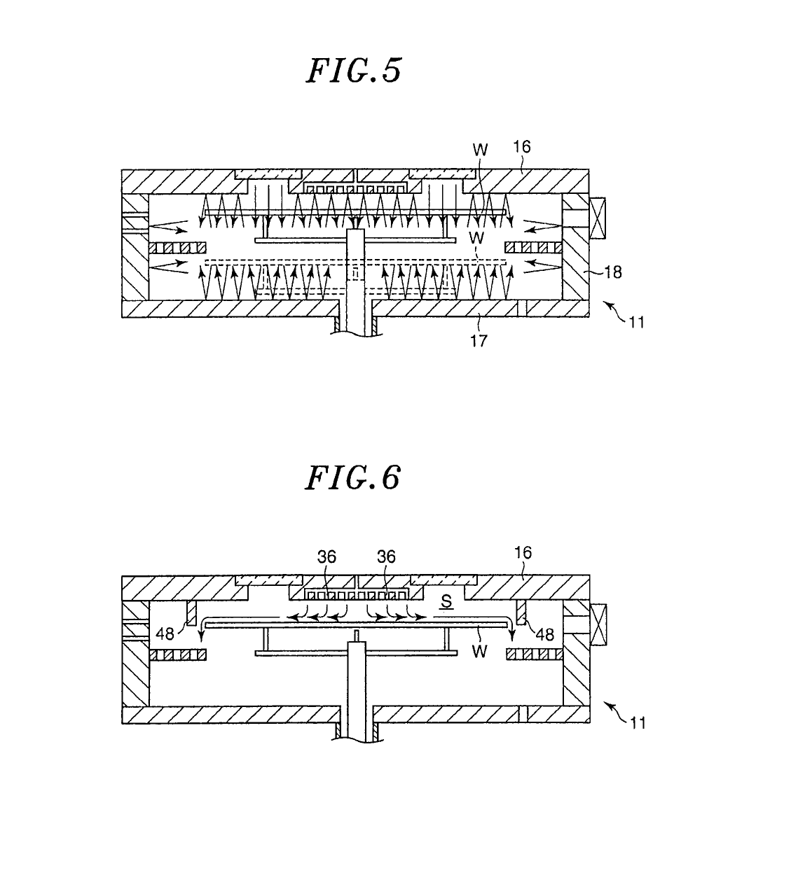

Since the microwaves are localized in the chamber 11 as described above, the heat treatment temperature of the wafer W may be controlled by moving the wafer W in the chamber 11. For example, as shown in FIG. 5, the wafer W is moved in a vertical direction by the supporting mechanism 13 in the chamber 11 where the microwaves (indicated by the arrows in FIG. 5) are reflected by the inner surfaces of the ceiling portion 16, the bottom portion 17, and the sidewalls 18.

Specifically, when the microwaves are localized at an upper portion of the chamber 11, the amount of microwaves irradiated to the wafer W can be increased by moving the wafer W upward (as indicated by the solid line in FIG. 5) such that the heat treatment temperature of the wafer W is increased. Further, the amount of microwaves irradiated to the wafer W can be decreased by moving the wafer W downward (as indicated by the dotted line in the drawing) such that the heat treatment temperature of the wafer W is decreased.

The heat treatment of the wafer W may be carried out in a plurality of steps. In this case, the amount of microwaves irradiated to the wafer W can be changed by varying the position of the wafer W in the chamber 11 in each step such that the heat treatment temperature of the wafer W in each step is changed.

Further, when the wafer W is heated to a desired heat treatment temperature (step S24), the temperature of the wafer W can be increased while being uniformly maintained in the circumferential direction by horizontally rotating the wafer W. Further, the temperature of the wafer W can be quickly increased by moving the wafer W to a location where the microwaves are localized by the supporting mechanism 13.

Further, when the wafer W is subjected to heat treatment, the pressure in the chamber 11 is maintained at the atmospheric pressure that is substantially the same as the outside pressure. However, the pressure in the chamber 11 may be maintained at a pressure lower than the outside pressure by the pressure control of the pressure control valve 34 and the gas supply. Accordingly, even when unnecessary substances or gases are generated due to electric discharge caused by the microwaves scattering in the chamber 11, the unnecessary substances or gases can be confined in the chamber 11. As a result, it is possible to prevent the unnecessary substances or gases from being extruded to the outside of the chamber 11.

Subsequently, upon completion of the heat treatment of the wafer W, the introduction of the microwave into the chamber 11 is stopped, and the pressure in the chamber 11 is set to a pressure higher than the outside environment by the pressure control of the pressure control valve 34 and the gas supply. However, the horizontal rotation of the wafer W is continued, and the introduction of N₂ gas from the gas introducing mechanisms 14 into the chamber 11 is restarted. At this time, N₂ gas introduced through the gas inlet port 36 of the sidewall 18 flows along the surface of the wafer W, and N₂ gas introduced through the gas inlet port 36 of the ceiling portion 16 flows along the surface of the wafer W by centrifugal force. Therefore, the N₂ gases function as cooling gases for removing heat from the surface of the wafer W, and the wafer W is cooled by the N₂ gases (cooling step) (step S26).

However, if the temperature of the wafer W is excessively decreased due to supercooling of the wafer W, thermophoretic force is not applied to particles flowing in the chamber 11 and thus, the particles may be attached to the wafer W. For this reason, the horizontal rotation of the wafer W is stopped during the introduction of N₂ gases into the chamber 11. Accordingly, the supercooling of the wafer W and the adhesion of particles can be prevented. Further, when the wafer W in a relatively high temperature state is unloaded to the outside of the chamber 11, thermal oxidation reaction occurs by the heat of the wafer W and a thermal oxide film may be formed on the surface of the wafer W. Therefore, it is preferable to unload the wafer W to the outside after the wafer W is cooled to a temperature of about 500° C. to 600° C.

Next, in a state where the pressure in the chamber 11 is maintained at a pressure higher than the outside environment, the wafer W is unloaded to the outside from the chamber 11 by moving the gate valve 22 to open the loading/unloading port 21 (step S27). When the loading/unloading port 21 is opened, the inside and the outside of the chamber 11 communicate with each other. Since, however, the pressure in the chamber 11 is maintained at a higher pressure than the outside environment, the atmosphere containing O₂ gas can be prevented from entering the chamber 11 from the outside. Accordingly, the generation of oxides on the surface of the wafer W or the like during heat treatment of a next wafer W can be reliably prevented.

In accordance with the microwave heat treatment shown in FIG. 2, the intrusion of O₂ gas, which is contained in the atmosphere, into the chamber 11 can be prevented by setting the pressure in the chamber 11 to a pressure higher than the outside environment during the loading and the cooling of the wafer W. Further, the atmosphere (containing O₂ gas) is discharged from the chamber 11 by introducing N₂ gas into the chamber 11 prior to the heat treatment of the wafer W by using microwaves. Accordingly, the generation of oxides during the heat treatment of the wafer W using microwaves can be suppressed.

Particularly, since N₂ gas is injected onto the surface of the rotating wafer W through the gas inlet ports of the gas introducing mechanism 14 provided at the ceiling portion 16, O₂ gas existing near the surface of the wafer W can be extruded and reliably removed by N₂ gas flowing toward the peripheral portion of the wafer W along the surface of the wafer W due to the centrifugal force caused by the rotation of the wafer W.

While the invention has been shown and described with respect to the embodiments, the present invention is not limited to the above embodiments.

For example, as shown in FIG. 6, there may be provided a wall 48 that protrudes downward from the ceiling portion 16. The wall 48 defines an isolated space S in cooperation with the wafer W supported by the supporting mechanism 13. The surface of the wafer W faces the isolated space S, and N₂ gas is introduced through the gas inlet ports 36 of the ceiling portion 16. The volume of the isolated space S is smaller than that of the chamber 11. Therefore, O₂ gas can be quickly removed from the isolated space S by using N₂ gas as a purge gas, and the contact between the surface of the wafer W, on which the semiconductor devices are formed, and gas can be prevented during the heat treatment. Accordingly, the generation of oxides on the surface of the wafer W can be reliably suppressed.

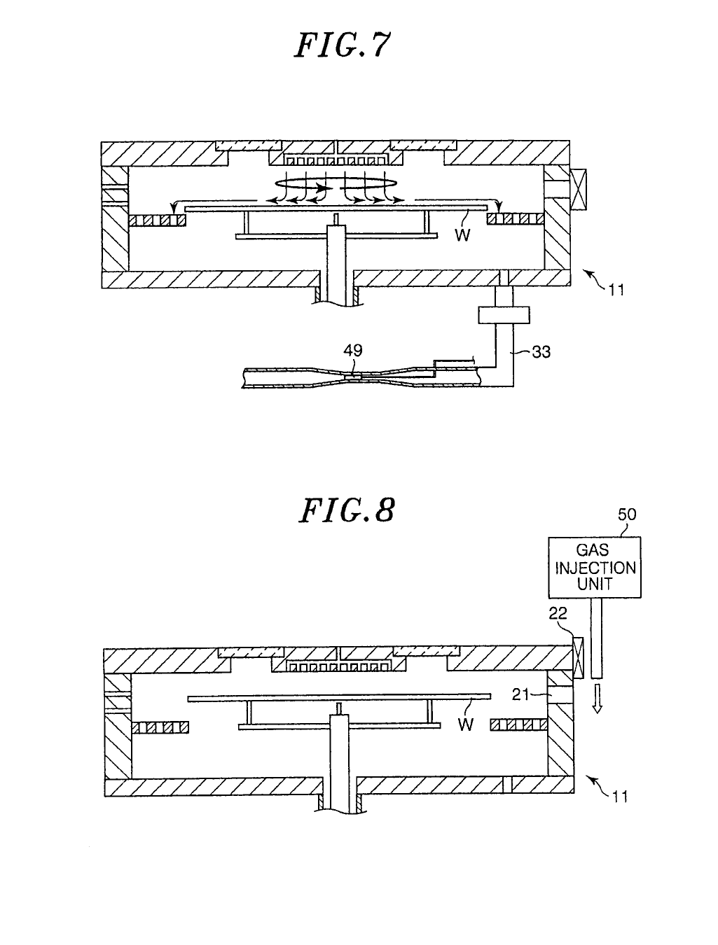

Moreover, as shown in FIG. 7, a backflow prevention unit, e.g., an aspirator 49, may be provided at the gas exhaust line 33 to prevent a backflow of the atmosphere into the chamber 11 from the outside. As a consequence, the backflow of the atmosphere containing O₂ gas into the chamber 11 can be prevented, and this makes it possible to reliably prevent the generation of oxide on the surface of the wafer W.

In addition, as shown in FIG. 8, a gas injection unit for injecting a predetermined gas, e.g., an inert gas other than O₂ gas, downward may be provided near the upper portion of the gate valve 22 outside the chamber 11. When the loading/unloading port 21 is opened upon completion of the heat treatment of the wafer W, N₂ gas in the chamber 11 is discharged to the outside. Since, however, N₂ gas is heated by radiant heat from the wafer W or the like, N₂ gas is discharged to the outside through the upper portion of the loading/unloading port 21. At this time, as a counter-reaction to the discharge of the heated N₂ gas, the outside atmosphere (containing O₂) of a relatively low temperature may flow backward into the chamber 11 through the lower portion of the loading/unloading port 21.

To this end, when the loading/unloading port 21 is opened by the gate valve 22, the gas injection unit 50 injects an inert gas downward such that the loading/unloading port 21 is covered by the flow of the inert gas (indicated by the white arrow in FIG. 8). Accordingly, the loading/unloading port 21 is isolated from the outside, and the backflow of the atmosphere containing O₂ gas into the chamber 11 can be prevented. As a result, the generation of oxides on the surface of the wafer W can be reliably suppressed.

While the invention has been shown and described with respect to the embodiments, it will be understood by those skilled in the art that various changes and modifications may be made without departing from the scope of the invention as defined in the following claims.

What is claimed is:

1. A microwave processing method for processing an object in a processing chamber using microwaves, comprising:
loading the object into the processing chamber in a state where a pressure in the processing chamber is higher than that of an outside environment;
discharging O₂ gas from the processing chamber by introducing N₂ gas into the processing chamber;
performing heat treatment on the object by introducing microwaves into the processing chamber from which the O₂ gas has been discharged; and
cooling the object in a state where the pressure in the chamber is higher than that of the outside environment.

2. The method of claim 1, wherein in the discharging of the O₂ gas, the N₂ gas is injected onto a surface of the object while horizontally rotating the object.

3. The method of claim 1, wherein in the heat treatment, the processing chamber is maintained at a pressure lower than that of the outside environment.

4. The method of claim 2, wherein in the heat treatment, the processing chamber is maintained at a pressure lower than that of the outside environment.

5. The method of claim 1, wherein in cooling of the object, the N₂ gas is introduced into the processing chamber, the object is rotated horizontally, and the rotation of the object is stopped during the introduction of the N₂ gas.

6. The method of claim 2, wherein in cooling of the object, the N₂ gas is introduced into the processing chamber, the object is rotated horizontally, and the rotation of the object is stopped during the introduction of the N₂ gas.

7. The method of claim 3, wherein in cooling of the object, the N₂ gas is introduced into the processing chamber, the object is rotated horizontally, and the rotation of the object is stopped during the introduction of the N₂ gas.

8. The method of claim 4, wherein in cooling of the object, the N₂ gas is introduced into the processing chamber, the object is rotated horizontally, and the rotation of the object is stopped during the introduction of the N₂ gas.

9. The method of claim 1, wherein in the heat treatment, the object is moved in a vertical direction in the processing chamber.

10. The method of claim 2, wherein in the heat treatment, the object is moved in a vertical direction in the processing chamber.

11. A microwave processing apparatus comprising:
a processing chamber configured to accommodate therein an object to be processed;
a microwave introducing unit configured to introduce microwaves into the processing chamber; and
a gas introducing unit configured to introduce N₂ gas into the processing chamber,
wherein the gas introducing unit introduces the N₂ gas into the processing chamber, prior to the introduction of the microwaves into the processing chamber by the microwave introducing unit, to allow O₂ gas to be discharged from the processing chamber.

12. The apparatus of claim 11, wherein the processing chamber has a wall for defining an isolated space in cooperation with the object accommodated in the processing chamber, and the gas introducing unit introduces the N₂ gas into the isolated space.

13. The apparatus of claim 11, further comprising: a gas exhaust unit configured to discharge a gas in the processing chamber, wherein the gas exhaust unit includes a backflow prevention unit for preventing a gas from backflowing from the outside into the processing chamber.

14. The apparatus of claim 12, further comprising: a gas exhaust unit configured to discharge a gas in the processing chamber, wherein the gas exhaust unit includes a backflow prevention unit for preventing a gas from backflowing from the outside into the processing chamber.

15. The apparatus of claim 11, wherein the processing chamber has a loading/unloading port of the object, and a gas injection unit for injecting a predetermined gas is provided outside the processing chamber to cover the loading/unloading port with the flow of the predetermined gas.

16. The apparatus of claim 12, wherein the processing chamber has a loading/unloading port of the object, and a gas injection unit for injecting a predetermined gas is provided outside the processing chamber to cover the loading/unloading port with the flow of the predetermined gas.

17. The apparatus of claim 13, wherein the processing chamber has a loading/unloading port of the object, and a gas injection unit for injecting a predetermined gas is provided outside the processing chamber to cover the loading/unloading port with the flow of the predetermined gas.

18. The apparatus of claim 14, wherein the processing chamber has a loading/unloading port of the object, and a gas injection unit for injecting a predetermined gas is provided outside the processing chamber to cover the loading/unloading port with the flow of the predetermined gas.
